(19) United States
(12) Patent Application Publication
(10) Pub. No.: US 2005/0204391 A1
(43) Pub. Date: Sep. 15, 2005

(54) Methods and systems for a secure media computing environment

(76) Inventors: Frank A. Hunleth, Rockville, MD (US); Daniel S. Simpkins, Bethesda, MD (US); Stephen Scheirey, Urbana, MD (US)

Correspondence Address: Steven M. duBois;Potomac Patent Group, PLLC, P.O. Box 270, Fredericksburg, VA, 22404, US

(21) Appl. No.: 11/064,307

(22) Filed: Feb. 23, 2005

Related U.S. Application Data
(60) Provisional application No. 60/546,858, filed on Feb. 23, 2004.
(60) Provisional application No. 60/546,857, filed on Feb. 23, 2004.

(51) Int. Cl. H04N 7/173; H04N 7/18; H04N 7/16

(52) U.S. Cl. 725/78; 725/25; 725/30; 725/74; 725/112; 725/113; 725/109

(57) ABSTRACT

Systems and methods for providing secure access to cable data are described. A split hardware and/or software architecture are provided to enable general computer access to safe APIs while protecting privileged APIs and operator content.

### RELATED APPLICATIONS

This application is related to, and claims priority from, U.S. Provisional Patent Application Ser. No. 60/546,858, filed on Feb. 23, 2004, entitled “A Secure Media Computing Environment”, the disclosure of which is incorporated here by reference. This application is also related to, and claims priority from, U.S. Provisional Patent Application Ser. No. 60/546,857, filed on Feb. 23, 2004, entitled “A Secure Split OCAP Computing Environment”, the disclosure of which is incorporated here by reference.

### BACKGROUND

The present invention generally describes a framework for providing a secure media computing environment and methods associated therewith and, more particularly, the present invention describes exemplary techniques and structures which enable computers to operate as set-top boxes within an OpenCable environment.

Technologies associated with the communication of information have evolved rapidly over the last several decades. Television, cellular telephony, the Internet and optical communication techniques (to name just a few things) combine to inundate consumers with available information and entertainment options. Taking television as an example, the last three decades have seen the introduction of cable television service, satellite television service, pay-per-view movies and video-on-demand. Whereas television viewers of the 1960s could typically receive perhaps four or five over-the-air TV channels on their television sets, today's TV watchers have the opportunity to select from hundreds and potentially thousands of channels of shows and information. Video-on-demand technology, currently used primarily in hotels and the like, provides the potential for in-home entertainment selection from among thousands of movie titles. Digital video recording (DVR) equipment such as offered by TiVo, Inc., 2160 Gold Street, Alviso, Calif. 95002, further expand the available choices.

Set-top boxes (STBs) are industry standard devices which are used to control the secure interaction between incoming cable content and the controlled display of information based on the cable content on, e.g., a television screen. Traditional STBs consist of secure, standalone computing environments that are closed to new applications, e.g., user installed or third party applications, to provide a secure mechanism for distributing the cable content in a manner which is consistent with a cable operator's digital rights management (DRM) program, as well as to provide a uniform viewing experience and reliability. More recently, PCI plug-in cards have been developed for the personal computer that enable reception and display of analog cable content, however these PCI plug-in cards lack authorization capability, media protection and make no provision for DRM, which renders such cards unable to deliver digital cable content.

Today, DRM and other access controls are typically mandatory components for standards associated with the provision of digital cable content. One such standard, the Open Cable Applications Platform (OCAP) promulgated by Cable Televisions Laboratories, Inc., provides a software layer specification that is intended to enable developers of interactive television services and applications to design such products which are compatible with various different cable television systems, independent of differences in set-top or television receiver hardware. However there currently are no solutions available for enabling a PC to consume digital cable content by, for example, rendering the PC capable of operating as an OCAP compatible set-top.

### SUMMARY

Systems and methods according to the present invention address these needs and others by providing a method for generating video output based on data received from a cable input including the steps of receiving the cable input in an access module, demodulating and providing conditional access to at least some of the cable input in the access module, transferring the at least some of the cable input from the access module to a media processing module, receiving computer-generated graphics in the media processing module and mixing the at least some of the cable input and the computer-generated graphics in the media processing module to generate the video output.

According to one exemplary embodiment of the present invention, a cable data processing system includes a first module, inaccessible by a general processor associated with a computer, including privileged application program interfaces (APIs) for operating on an incoming cable data stream and a second module, accessible by the general processor associated with the computer, including safe APIs for operating on the incoming cable data stream.

According to another exemplary embodiment of the present invention, a cable data input card for a computer includes an RF input capable of receiving a coaxial cable that conveys cable data to the cable data input card, a PCMCIA slot having a PCMCIA card inserted therein, the PCMCIA card including a conditional access function for selectively allowing access to data streams within the cable data and an output which outputs those of the data streams authorized by the conditional access function to a secure interconnect.

### BRIEF DESCRIPTION OF THE DRAWINGS

The accompanying drawings illustrate exemplary embodiments of the present invention, wherein:

FIG. 1 depicts a media system including a general media processing unit handling OCAP input according to an exemplary embodiment of the present invention;

FIG. 2 shows software layers for a conventional OCAP STB;

FIG. 3 illustrates hardware associated with a conventional OCAP STB;

FIG. 4 shows an exemplary hardware and software partitioning for media processing units according to exemplary embodiments of the present invention;

FIG. 5 shows exemplary software layers for media processing units according to an exemplary embodiment of the present invention;

FIG. 6 depicts software partitioning between an access module and a media processing module according to an exemplary embodiment of the present invention;

FIG. 7 is a table illustrating exemplary locations for specific software modules used in an exemplary OCAP compliant media processing unit according to an exemplary embodiment of the present invention;

FIG. 8 illustrates the PC module software architecture of FIG. 6 in more detail according to an exemplary embodiment of the present invention;

FIG. 9 illustrates the access module software architecture of FIG. 6 in more detail according to an exemplary embodiment of the present invention;

FIG. 10 depicts an exemplary hardware configuration for media processing units according to an exemplary embodiment of the present invention;

FIG. 11 shows exemplary hardware modules which can be included in a media processing unit according to an exemplary embodiment of the present invention;

FIG. 12 shows media flows according to an exemplary embodiment of the present invention;

FIG. 13 is a table showing descriptions of flows illustrated in FIG. 12;

FIG. 14 shows digital cable programming flows according to an exemplary embodiment of the present invention;

FIG. 15 shows analog cable programming flows according to an exemplary embodiment of the present invention;

FIG. 16 depicts media mixing flows in a media processing unit according to an exemplary embodiment of the present invention; and

FIG. 17 shows playback and recording flows in a media processing unit according to an exemplary embodiment of the present invention.

### DETAILED DESCRIPTION

The following detailed description of the invention refers to the accompanying drawings. The same reference numbers in different drawings identify the same or similar elements. Also, the following detailed description does not limit the invention. Instead, the scope of the invention is defined by the appended claims.

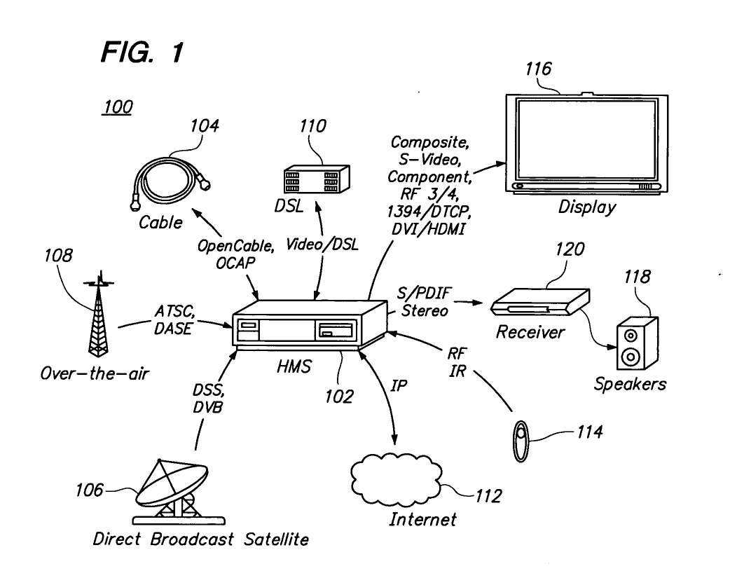

In order to provide some context for this discussion, an exemplary aggregated media system 100 in which the present invention can be implemented will first be described with respect to FIG. 1. Those skilled in the art will appreciate, however, that the present invention is not restricted to implementation in this type of media system and that more or fewer components can be included therein. Therein, the central component is a media processing unit 102 which includes at least one general processor with a split hardware and/or a split software architecture which supports DRM and other features of OCAP, while also enabling other applications to have access to certain data streams associated with the cable input 104, as will be described in more detail below. Among other things, media processing unit 102 is implemented using a modular approach for providing cable (and other media delivery system) connectivity to PCs. Some features of media processing units according to exemplary embodiments of the present invention include:

1.The ability to connect to digital and analog cable systems.

2. Conditional Access processing in accordance with, for example, OpenCable standards.

3. Modular expandability to include additional tuners and conditional access functions for extra cable channels, Direct Broadcast Satellite (DBS), NTSC and ATSC Broadcast, and DOCSIS cable Modem.

4. An open PC-based platform for creation and execution of advanced user interface and control functions.

5. Effective security to ensure Conditional Access, Content Protection, and Digital Rights Management integrity.

The general processor(s) within media processing unit 102 can host user applications (e.g., a PC CPU and graphics). This enables, among other things, a user or third party software provider to write applications that use various STB services which are typically closed to external control. These features further enable cable operators to write applications that use the advanced capabilities of the PC as traditional STBs are low powered. The exemplary system 100 also includes a number of other content sources which provide content to the media processing unit 102 using respective standards/techniques as illustrated in FIG. 1, e.g., broadcast satellite 106, over-the-air television 108, video sources 110, and the Internet 112. A remote control device 114 can be used to control the media processing unit 102 to generate outputs based on the input content governed by higher level display applications running on the media processing unit 102. Exemplary output devices include a display 116 and speakers 118 (via receiver 120).

As mentioned above, an exemplary standard associated with the secure handling of cable content is OCAP, which will be used to describe exemplary embodiments of the present invention herein. Those skilled in the art will appreciate, however, that standards other than OCAP can be used in conjunction with other exemplary embodiments of the present invention. Although some features of OCAP are described herein, the interested reader is referred to OpenCable™ Application Platform Specification, OCAP 1.0 Profile, OC-SP-OCAP1.0-I14-050119, Jan. 19, 2005, available from Cable Television Laboratories, Inc., 858 Coal Creek Circle, Louisville, Colo., 80027-9750, the disclosure of which is incorporated here by reference.

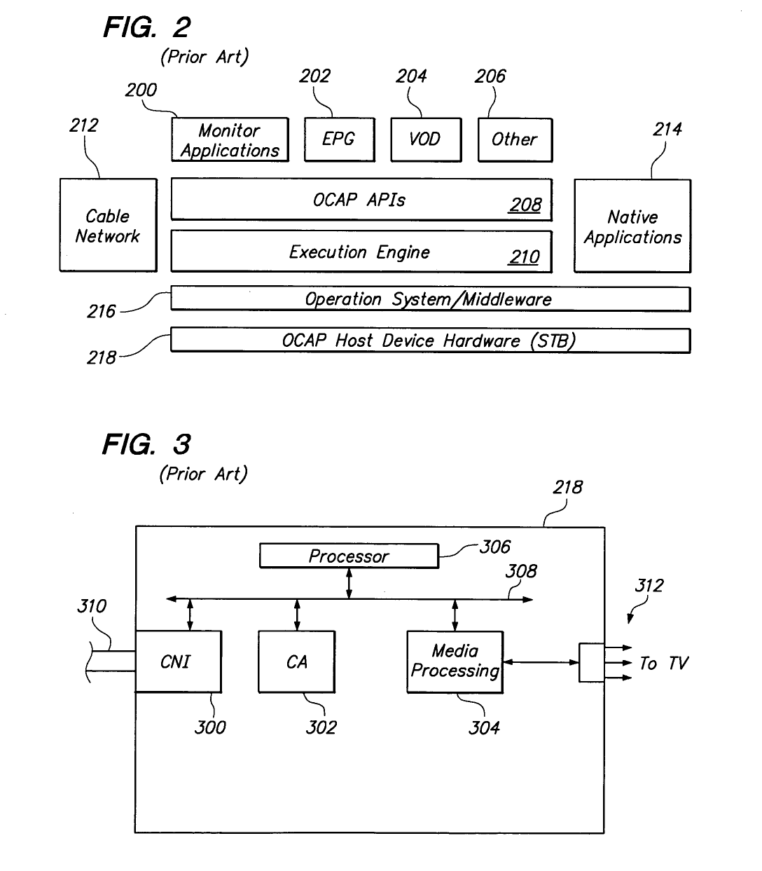

To better understand the split hardware and/or split software architecture according to the present invention, a description of the OCAP software architecture for conventional STBs will first be discussed with respect to FIG. 2. Therein, a number of applications 200-206, including an electronic program guide 202 and video-on-demand application 204, receive cable content via the OCAP application program interfaces (APIs) 208, which are specified in the above-incorporated by reference document. The monitor application 200 provides various functions which are used to manage the lifecycle of the other applications including functions such as resource management, security, etc. The EPG application 202 provides a user interface by which the user can, for example, select television channels. VOD application 204 is an example of another application which can be supported by the OCAP software architecture, however various other types of applications can be supported as well, as indicated by block 206.

The execution engine 210 provides a platform-independent interface that permits programs and content from various service providers to run on different hardware and software supplied by different manufacturers. The execution engine 210 can be implemented using a Java Virtual Machine (JVM) and Java APIs. The cable network sub-system 212 supports communications between application components which may be distributed and cable network protocols. The native application 214 provides support for legacy functionality as well as OCAP support for applications requiring faster runtimes. The operating system/middleware 216 provides support for the specific set-top box hardware 218 on which it is to be executed. Among other functions, software layer 216 supports task/process scheduling, interrupt handling, device drivers, etc. Readers interested in more details regarding the various software layers are referred to the above-incorporated by reference specification.

The conventional set-top box hardware 218 includes a number of different subsystems as shown in FIG. 3. These include, for example, a cable network interface (CNI) 300 which provides general service access (e.g., including a cable tuner, various demodulators and an out-of-band transceiver), a conditional access (CA) subsystem 302 (which selectively grants access to specific services to customer(s) associated with the STB), a media processing subsystem 304 (e.g., to process video, graphics and audio data for output presentation) and a processor 306 to control these subsystems via interconnect 308 (e.g., including a ROM, flash memory and RAM, all not shown). Cable content is provided to the STB 218 via cable input 310 and output to a television via outputs 312.

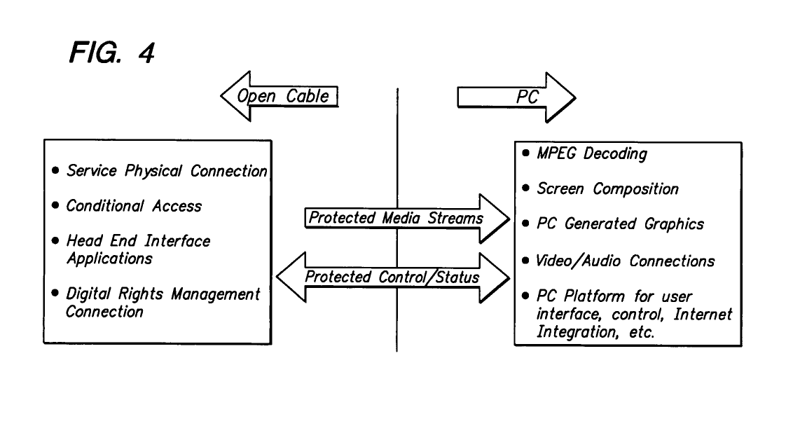

As mentioned above, exemplary embodiments of the present invention split the OCAP functionality in a manner which enables developers to have more freedom to design applications handling the cable content, while at the same time protecting the secure environment required in OCAP-compliant devices. An exemplary functional partitioning for media processing units according to exemplary embodiments of the present invention is shown in FIG. 4. Therein, a split architecture associated with exemplary embodiments of the present invention wherein, on the one hand, the full suite of (or substantially the full suite of) standardized (e.g., OpenCable) requirements are met, while on the other hand the compliant functionality is adapted to an open PC environment to format the copy-protected content, combine it with computer-generated graphics, and produce media output, e.g., on industry standard interfaces that preserve the Digital Rights Management (DRM) integrity of the system. Media processing units and techniques according to the present invention, open up the application environment for cable-connected systems. In FIG. 4, the arrows that cross the line in the center conceptually illustrate the data streams between the portions of the split architecture which enable these features. The upper arrow represents the ability of exemplary embodiments of the present invention to transport protected content data streams from the Conditional Access domain into the PC display and to combine these streams with locally generated graphics with the DRM protections they need. The second arrow represents the ability of exemplary embodiments of the present invention to permit PC-hosted software to access as much of the OpenCable API (and vice versa) as possible without violating the integrity of the Conditional Access domain of the service provider or the Content Protection domain of the content provider.

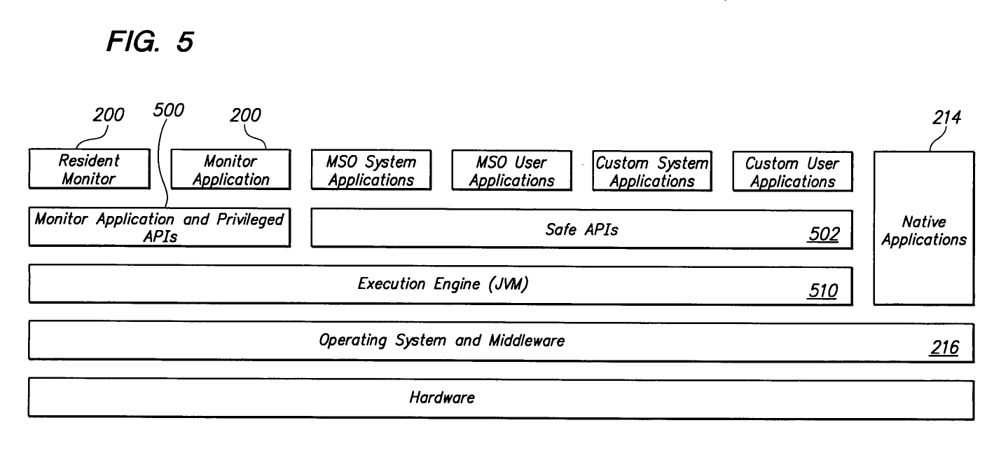

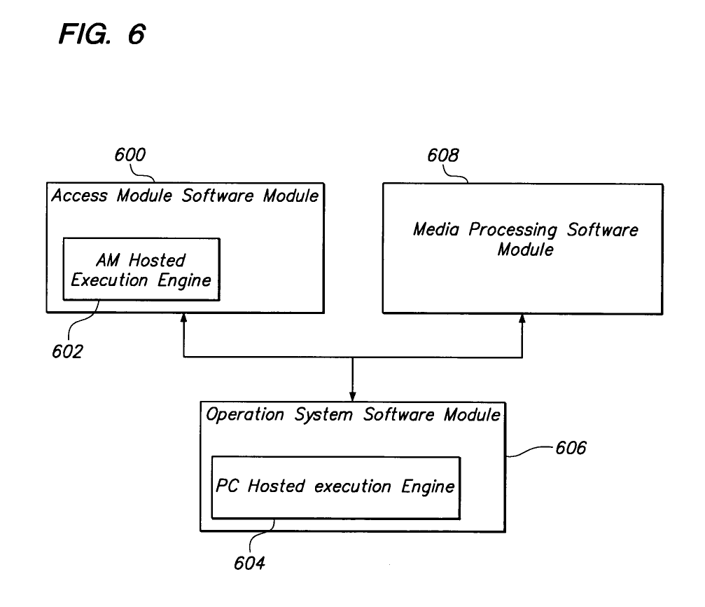

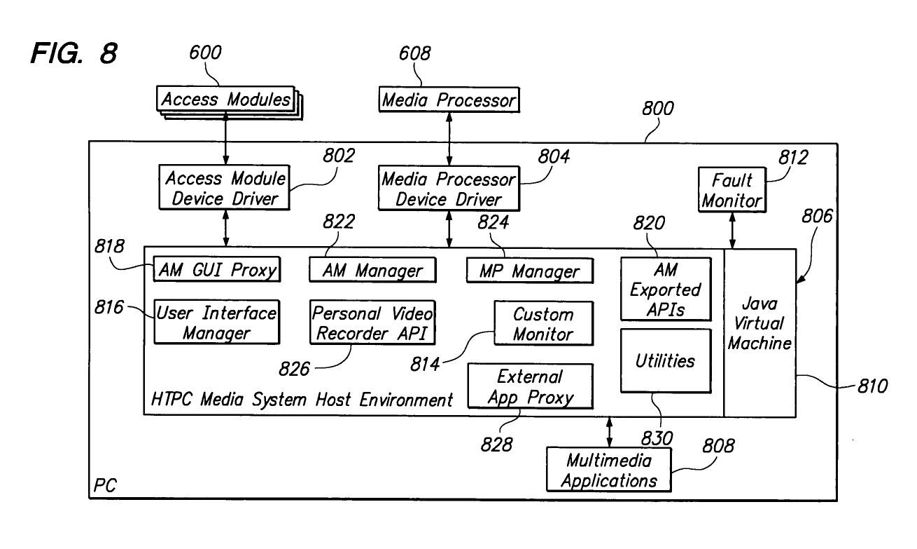

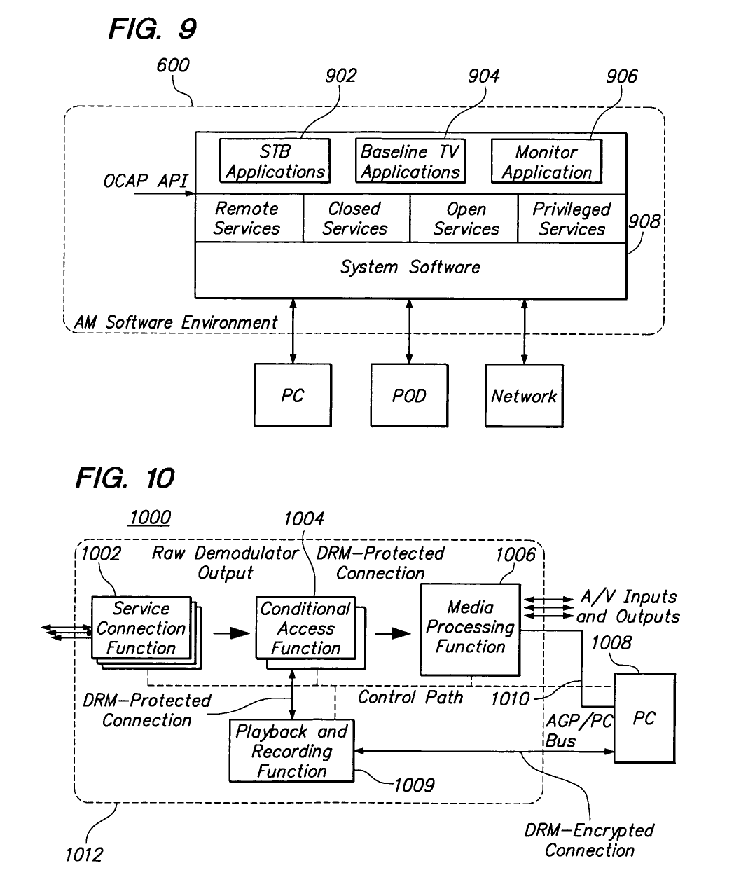

The split nature of systems and methods according to exemplary embodiments of the present invention can be described from both a hardware and a software perspective. Beginning first with the software perspective, FIG. 5 illustrates software layers for media processing units according to an exemplary embodiment of the present invention. Therein, the software layers which are unchanged (or substantially unchanged) relative to the OCAP software architecture are referred to using the same reference numerals as those used in FIG. 2. Of particular interest with respect to the present invention, note that the API portion of the software stack is split into two groups: privileged APIs 500 and safe APIs 502. An exemplary segregation of OCAP APIs is provided below, however one exemplary segregating factor is that APIs which are required by the MSO (Multiple Service Operator) monitor application, as well as APIs which may affect the ability of the MSO to control the environment, including security and conditional access, are considered privileged. As shown in FIG. 6, the privileged APIs 500 are hosted in a secure portion 602 of the execution engine (part of access module software 600), whereas the safe APIs 502 are hosted in a portion 604 of the execution engine which is controlled by the PC's software module 606. Since the applications and APIs are intended to pass data back and forth, communications between the elements illustrated in FIG. 6 can, for example, be performed using the Java Remote Method Invocation (RMI) technique. The media processing subsystem software can also be provided as a separate module 608. Splitting the software architecture in this way, enables the safe APIs, and their related applications, to have access to the additional computing resources of the PC (as compared to the conventional set-top box implementation wherein the processor 306 is typically more limited in its computing resources). At the same time the privileged APIs, whose access by the PC cannot be allowed in order to provide an OCAP compliant device, are hosted on a separate, secure device, as will be described in more detail below with respect to exemplary hardware configurations of the present invention. Like the APIs, portions of the execution engine (JVM) 510 are also distributed between the access module software module(s) 600 and PC software module 606. More details regarding exemplary software architectures for the PC software module 606 and the access software module 600 are provided below with respect to FIGS. 8 and 9, respectively.

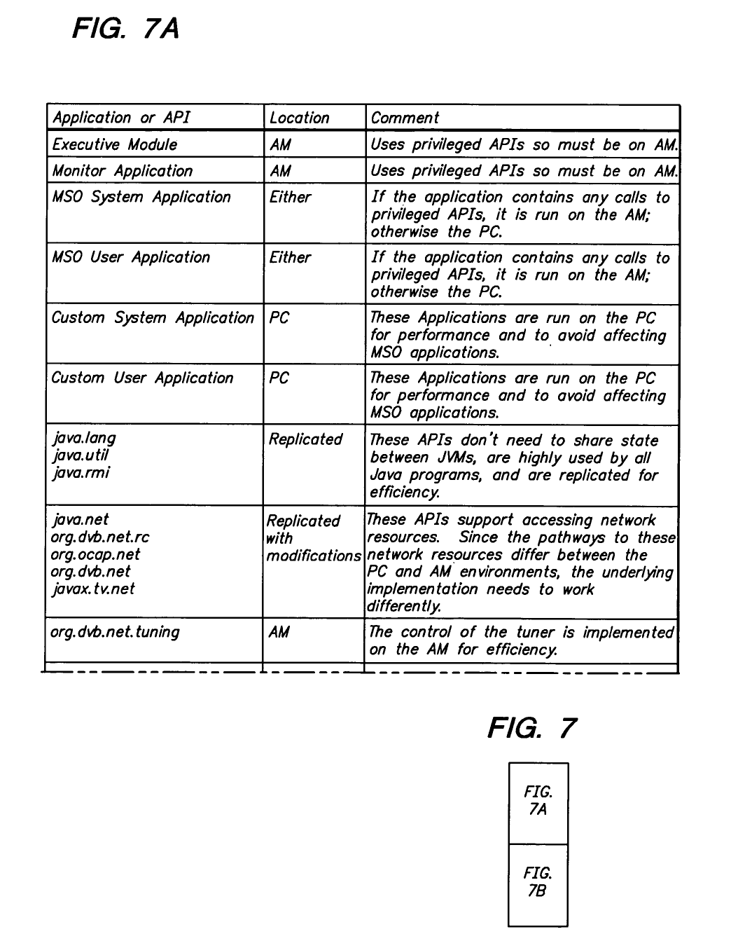

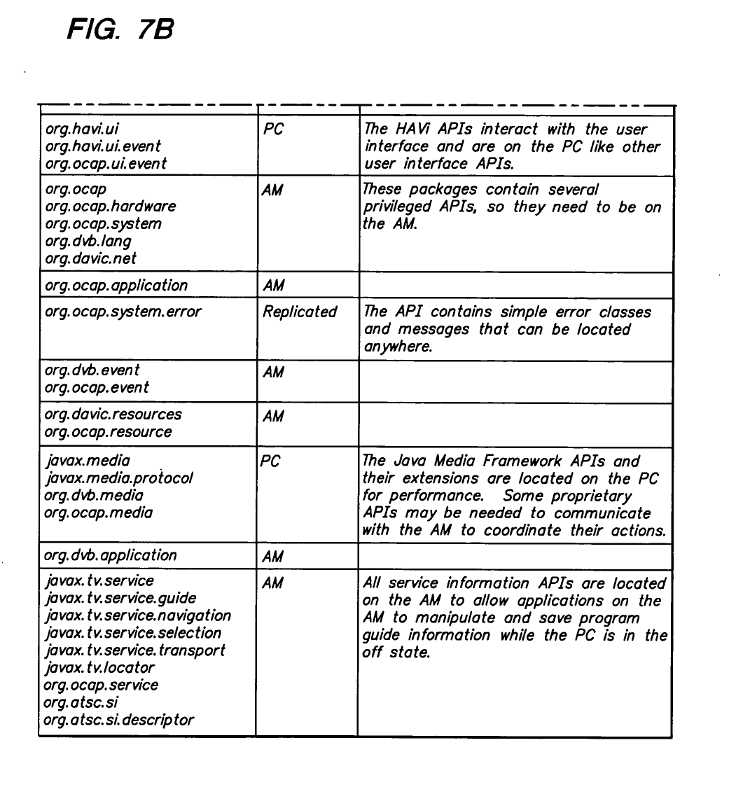

To further describe an exemplary split software architecture according to an exemplary embodiment of the present invention, FIG. 7 provides a table showing an explicit hosting location for various applications and APIs. It should be noted that the example provided in FIG. 7 is purely illustrative and that the allocation of specific APIs and/or applications to either the access module (AM) or computer (PC) could vary. In the table, it will be noted that in addition to allocating each application and API to a specific one of the AM hosted engine 602 or the PC hosted engine 604, other possibilities exist. For example, some APIs and/or applications can be hosted on both the AM and the PC, in which case the table refers to those APIs and/or applications as “Replicated”. In some cases the location of the API and/or application is not significant to the provision of, for example, security or performance and may be allocated to either module in which case the table refers to those APIs and/or applications as “Either”.

Since exemplary embodiments of the present invention provide remote call functionality using the Java RMI technique, it may be the case that neither the user of an application or an API will not be able to determine its particular location (e.g., on the access module, the PC or both) for a particular implementation of the present invention. However, generic code stubs can be provided for ready access to render this abstraction easy to use and enable code distribution to be freely changed. A more detailed, yet purely illustrative, embodiment of the software architecture for the PC software module of media processing units according to the present invention is provided in FIG. 8. Therein, an example is shown for a PC running a Windows operating system although those skilled in the art will appreciate that the present invention is applicable to general processors running other operating systems. This exemplary software architecture 800 has two main components: device drivers 802, 804 and a main program 806 called the HTPC Media System Host Environment (HMSHE). The devices drivers 802, 804 are C or C++ Windows kernel drivers that provide the code necessary to communicate with the software and hardware on the access module(s) 602 and the media processor 608. The HMSHE 806 is a Windows user-mode application that performs high level access module and media processor tasks and executes multimedia applications 808. One purely illustrative example of a multimedia application 808 is described in U.S. patent application Ser. No. 10/768,432, filed on Jan. 30, 2004, entitled “Control Framework with a Zoomable Graphical User Interface for Organizing, Selecting and Launching Media Items”, the disclosure of which is incorporated here by reference.

The access module device driver 802 initializes the access module(s) 600 and registers the access module(s) 600 with the Windows OS. The driver 802 is dormant until the HMSHE application 806 is started at which point it handles all low level communications with the access module(s) 600. The media processor device driver 804 can be implemented as an accelerated video card device driver that has extended APIs to control presentation of content from the access module(s) 600. The Java Virtual Machine (JVM) 810 in the HMSHE 806 runs both the user interface code on the PC and runs APIs from the access module(s) 600 as part of the execution engine 510. Because of this, the JVM 810 is capable of supporting the Java APIs that any application program needs and should be fault tolerant to the high level of faults which can be expected from audio/visual equipment. For fault tolerance, two exemplary embodiments of the JVM 810 can be considered. First, each application can be executed within a distinct JVM 810 to isolate faults and communicate via RMI for API calls. Second, all applications can be executed in a single JVM 810 and a fault monitor 812 can be used to restart the JVM 810 upon a crash or hang.

The custom monitor 814 is the analogue to the monitor application 906 provided in the portion of the execution engine 510 resident in the access module software module 600 and described below. The custom monitor 814 is a central point of control for custom applications running on the JVM 810 on the HMSHE 806. Additionally, the custom monitor 814 is not under the control of any content provider for any access module 600. Specifically, the custom monitor 814 can have the following responsibilities according to an exemplary embodiment of the present invention:

1. Provide a system-wide mechanism for accessing the HMSHE 806 so that new applications can be programmatically registered and run.

2. Monitor all applications running on the JVM 810.

3. Assign permissions to applications.

4. Isolate applications from interfering with each other inside the JVM 810.

5. Provide a management interface to start and stop applications.

The user interface manager (UIM) 816 coordinates the use of all display real estate for the presentation of audio, video, and Internet applications. Depending on the use, the screen presentation area could be limited to a window or the full screen. Custom applications run in the HMSHE 806 coordinate with the UIM 816 to use the area available. If necessary, it is still possible to create windows and dialog boxes outside of this area, but if the user interface is more closely approximating a TV-style user interface, such application behavior is undesirable. The APIs exported by the UIM 816 support, for example, reserving locations, alpha blending overlapping reservations (if allowed), and recommending good areas of the screen from which to display messages. The heuristics used to make reservation decisions and suggestions may be customizable. Examples of different entities in media processing systems according to the present invention which may call the UIM 816, include:

1. The Access Module 600 through a TV watching program: The access module 600 provides an environment for MSO applications that provides the illusion of controlling the full display 116. The access module 600 accomplishes this by using a TV watching program that queries the UIM 816 and based on the results, communicates with other components to resize access module output accordingly.

2. A DVD Player

3. An MPEG/AVI player: In some cases, the MSO applications may start MPEG or AVI players within their output window when handling interactive content.

4. Java AWT frames from applications that provide no video output such as a CD or MP3 player

5. External applications: In this case, the UIM 816 reserves space on the display 116 even though nothing in the HMSHE 806 may use it. The external application can be directed to only use screen real estate in this reserved area and that the PC's operating system can perform alpha blending when needed.

The access module GUI Proxy 818 is a component that intercepts all GUI related API calls between the access module(s) 600and GUI APIs on the HMSHE 806. The AM GUI Proxy 818 has the responsibility of providing the appearance of total control of the screen to AM software (such as MSO applications) while receiving window placement and sizing from TV user interface software. This includes, for example, the following processing:

1. Resizing and translating coordinates in GUI requests to their appropriate offsets and sizes on the screen.

2. Processing GUI events such as mouse clicks to put them in the coordinate system of the AM.

The AM Exported APIs 820 include those execution engine APIs which have been allocated to run on the PC, e.g., those identified in the table of FIG. 7. The AM Manager 822 provides APIs to query statistics on the access module(s) 600 and to manage AM components that are not managed through other APIs (such as those specified by OCAP). Examples of the statistics that can be queried include IEEE 1394a statistics, tuner frequency statistics, and out-of-band modem statistics. The MP Manager 824 provides APIs to query statistics on the media processor 608 and manage MPEG-2 encoders and mixers at a high level. The Personal Video Recorder (PVR) API 826 provides a high level programmable interface to control record and media playback on one or more access module(s) 600. Additionally, recording and playback can occur simultaneously to enable PVR-type applications to be built. The External App Proxy 828 enables non-HMSHE aware applications to appear as part of a unified environment. The HMSHE 806 can also include a set of utilities 830 to simplify writing applications. These utilities 830 can include, for example, an event channel to support inter-application and user interface controller communication.

FIG. 9 shows the access module software 600 architecture in more detail according to an exemplary embodiment of the present invention. The access module software 600 can be implemented as a Java application environment that hosts MSO STB applications 902 and TV services 904 (e.g. closed captioning, parental control) in a secure manner. Since this module is a conduit for communications to the MSO, the access module guards the integrity of the MSO network from untrusted applications resident on the PC. The access module 600 also hosts the MSO's monitor application 906. The monitor application 906 gives the MSO control over software application execution and distribution of copyrighted material from the access module 600. Below these applications in the access module software stack are the OCAP API (e.g., those API resident in the access module (AM) as segregated in FIG. 7) and four types of services which these APIs provides. Each of these four types of services will be described in turn.

Privileged services are services which are only accessible by the monitor application 906 or those other applications to which the monitor application 906 gives its permission. One privileged service is video output control, which service enables applications control over both the quality and copy permissions of the video output from the access module 600. Privileged applications can disable the video feed to various outputs or constrain the video resolution. In addition, privileged applications can override the Copy Control Information (CCI) with these functions. Another privileged service is event filtering. The monitor application 906 has the capability to receive and filter all user interface events before distribution to the various applications. Within the context of the exemplary media processing devices according to exemplary embodiments of the present invention, the event filtering service only allows event filtering for those events consumed by applications running on the access module 600 (AM-events). Other types of events (e.g. those consumed by applications running on the PC), may not be filterable. Application filtering is another privileged service which enable control by privileged applications over the execution of applications. Yet another privileged service is resource management control. Resource management control methods enable a privileged application to (1) resolve resource conflicts that may arise between other applications and (2) set specific resource access policies to applications.

Open services are implemented and used for execution by STB applications, but are also remotely available to PC applications. Examples of open services include service selection methods that provide a mechanism for channel change (tuning), and service information methods which provide the ability to find programs and also aid in the creation of program guide material. Recording control methods that enable applications to execute PVR functionality and event handling methods which enable the registration and reception of user input events (e.g. button clicks) by applications are other examples of open services. One-way network access methods are also open services available to applications on the AM as well as to applications on the PC. The system receives these unidirectional IP sessions in the broadcast stream using multicast IP addresses. Another example of open services are resource reservation methods that enable applications to request and reserve limited resources for their use. OCAP supports both synchronous and asynchronous resource reservations. The asynchronous facility enables an application to be put on a waiting list for a resource. OCAP has defined video, background video, graphics, MPEG decoder and tuner as limited resources.

Remote services are software methods that are accessible to access module applications, but which are physically implemented on the PC. JAVA RMI, for example, makes these available to access module applications. Exemplary remote services include graphics control methods hosted by the PC. There are several baseline applications (closed captioning, emergency alert system) that employ graphics control. In addition other applications such as VOD clients require graphics capabilities. The access module 600 can uses stubs to access java.awt and other APIs hosted on the PC.

Closed services are available to all applications that execute on the access module 600 but are not available to the PC. Closed services include infrastructure type services that may be replicated on the access module and the PC. They also include services the system identifies as potentially threatening to the MSO from the untrusted PC. Examples of such services are return channel access methods available only to applications on the access module.

At the bottom of the stack is the system software 908, which provides an abstraction to the hardware resources, housekeeping functions, general utilities, and communications services as well. The system provides communications to the PC, the POD, and to the cable network through in-band, out-of-band, and DOCSIS mechanisms.

From a hardware perspective, a media processing unit 1000 according to exemplary embodiments of the present invention can include the functional elements illustrated in FIG. 10. Therein, as described above, each device will include a service connection function (SCF) 1002 which takes the raw cable content received over the physical cable and transforms it into a raw demodulated output. The SCF can, more generally, receive inputs including cable, DBS, Broadcast Television (analog or digital), or DSL. For digital services, this function selects the appropriate channel and demodulates it to a bit stream. For analog services, the SCF 1002 converts the RF channel to an NTSC standard IF signal and then digitizes and encodes it using MPEG. The SCF 1002 uses a control path from the PC and/or the conditional access function 1004 (CAF) to implement channel selection. Some features supported by the SCF function 1002 tune to a specific channel under the control of either the CAF or the PC, providing a feedback signal to the controlling entity indicating the presence of a signal and (optionally) its quality, providing modular support for bi-directional Out-Of-Band (OOB) communications channels including an integral diplexer function, providing modular support for DOCSIS compliant cable modem function including integral diplexer, providing modular support for at least one additional tuner, including integrated splitter function, so that the SCF 1002 can bring in two or more RF channels to support picture-in-picture or simultaneous watch and record capability, demodulating all received Forward Application Transport (FAT) and OOB signals for delivery to the CAF 1004, accepting, modulating, and transmitting upstream data from the Conditional Access Function 1004 and providing analog video streams for each tuned channel to support NTSC television signals and compressing them to MPEG.

The raw demodulated output is provided to the conditional access function 1004 which selectively removes security features (e.g., encryption/scrambling) from the demodulated output based on the customer's particular access rights to the content stream. For cable systems, this means that a Point Of Deployment (POD) device is present and that the CAF complies with, e.g., the various CableLabs POD specifications. The CAF 1004 supports the system and privileged application software that form a secured environment for the service provider. Some features of CAF 1004 include: POD device support that delivers the media stream from the SCF 1002 to the POD and accepts the re-encrypted media stream from the POD, as well as other flows recited in the OCAP specifications, re-encryption of the media stream from the POD into a DTCP stream for subsequent transfer to less secure portions of the media processing unit (e.g., the PC), control processing to encapsulate the functions needed for secure and robust service provider interaction, support for privileged API functions and DRM-enabled recording output.

The CAF 1004 can transfer data streams via a DRM-protected connection to a media processing function 1006. The media processing function 1006 takes the demodulated, user-authorized cable content and processes it to provide suitable video and audio outputs to the PC 1008 over a suitable interconnect 1010, e.g., an AGP or PCI bus. Some functions performed by the media processing function 1006 include: providing a high resolution video graphics card for all PC operations, support for DRM-enabled MPEG input streams, MPEG decoding of incoming media streams, composition of video displays involving overlaying, scaling, and repositioning of media images and computer generated graphic images, dual independent display support, DRM-enabled display outputs, external audio inputs and digital audio mixing.

The Playback and Recording Function (PRF) 1009 is responsible for connecting MPEG streams that may carry protected content to media streams suitable for storage on openly accessible devices (e.g. disk drives of the PC). Some functions associated with PRF 1009 include: providing an IEEE 1394a interface that incorporates DTCP content protection carrying media streams, encryption and decryption sufficient to preserve DRM, and providing a bi-directional port carrying encrypted media streams. The PRF function 1009 can handle at least two encrypt and two decrypt streams simultaneously. Since during the playback of recorded media content, the PC may coordinates control and the PC cannot decrypt the media stream, the stream provided from the PRF 1009 to the PC 1008 can be annotated with unencrypted synchronization information so that temporal integrity can be maintained. Alternatively, the PRF 1004 could only encrypt the payload of the media stream, leaving the header information with the timestamp intact. The PC 1008 may provide control signaling to the service connection function 1002, conditional access function 1004 and media processing function 1006 via the illustrated control path in order to control these blocks to perform various functions which will be described in more detail below.

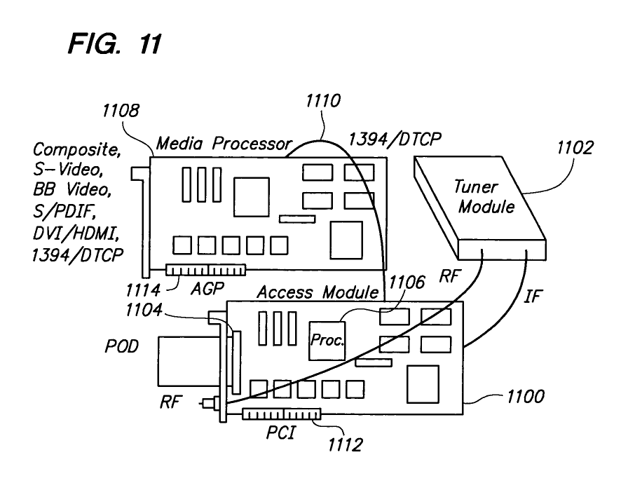

It should be noted that a “media processing unit”, as that phrase is used herein, may include both the hardware within block 1012 and PC 1008 or just the hardware within block 1012. In either case the hardware within block 1012 can be provided as one or more removable card modules which can be removably connected to the PC 1008 via, e.g, PCI slots (not shown) in the PC 1008. Such an exemplary embodiment of the present invention is shown in FIG. 11. Therein, a first removable card 1100 includes the components which form the access module and which store the applications and/or APIs which are allocated thereto as described above. The access module card 1100 receives the cable content at an RF port and passes the data streams on to a tuner module 1102 for demodulation. The tuner module 1102 could be disposed on the same physical board/card as the access module or it could be provided as a separate component. The access module 1100 receives a demodulated (IF) stream in return from the tuner module 1102 and uses a point-of-deployment (POD) PCMCIA card that is plugged into a socket 1104 mounted onto the access module 1100 to provide the conditional access function described above. The access module card 1100 also includes an embedded processor 1106 which hosts execution of content provider applications which are allocated to the access module based upon the split software architecture described above. The access module card 1100 encrypts protected content and sends it over a DRM-protected connection 1110, e.g., an IEEE-1394a bus with digital transmission copy protection (DTCP), to media processor card module 1108. DTCP is a technique which prevents illicit tampering or copying of the digital data passed over an IEEE 1394 bus. The media processor card module 1108 can be implemented as a high performance AGP video card extended to mix PC-generated and copy-protected content from the access module card 1100. The access module card 1100 and the media processor card 1108 are connected to the PC 1008 via pin connectors 1112 and 1114, respectively.

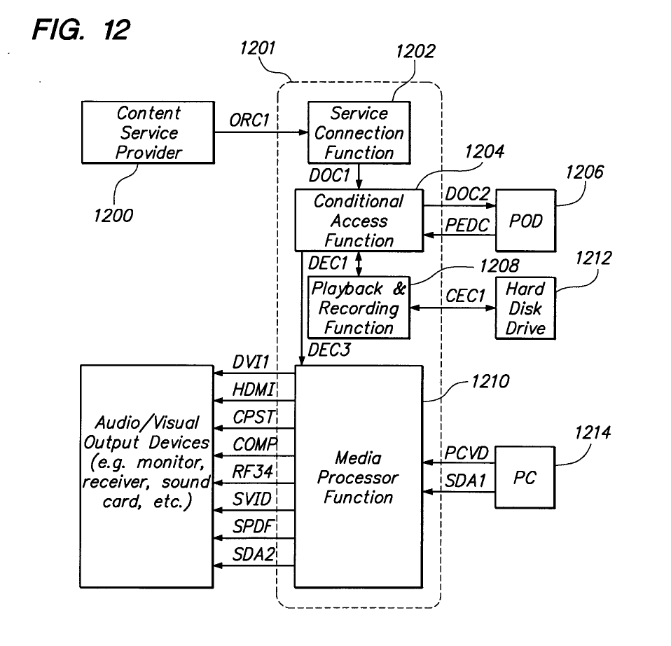

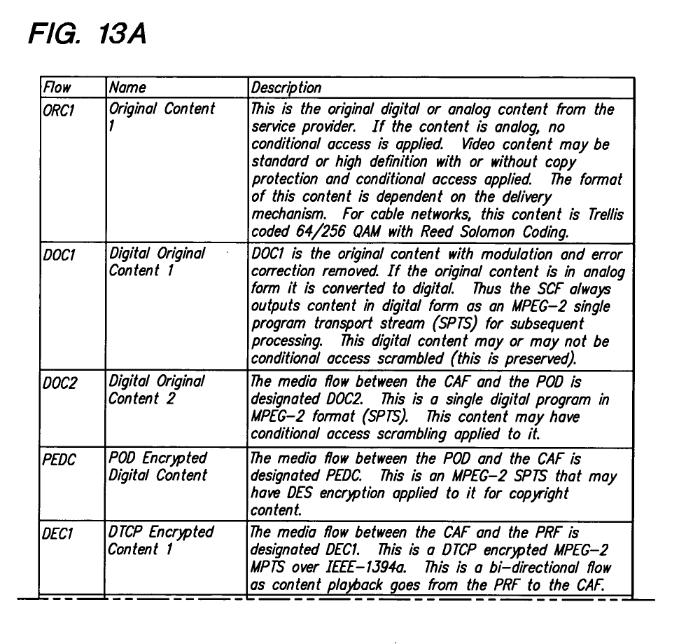

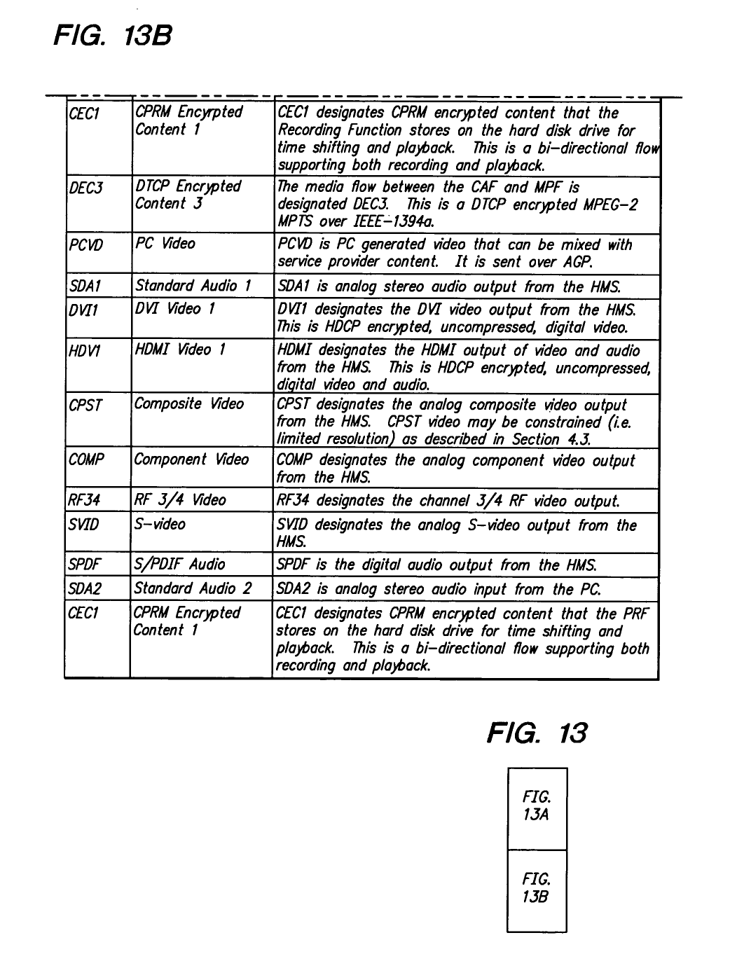

The above-described exemplary split architecture results in a media processing unit according to exemplary embodiments in the present invention wherein the hardware and software operate in tandem to generate media flows as will now be described with respect to FIG. 12. Generally, the Service Connection Function (SCF) 1202 within a media processing unit 1201 receives original, modulated content with forward error correction from one or more content service providers 1200. The SCF 1202 demodulates the content, digitizes it if it is analog, and then passes this on to the Conditional Access Function (CAF) 1204. The CAF 1204 sends digital content to the POD 1206 for Conditional Access decryption. The CAF 1204 then forwards this content over a secure DTCP-enabled FireWire connection to either the Media Processing Function (MPF) 1208 or to the Playback and Recording Function (PRF) 1210. The PRF 1208 stores encrypted content on the Hard Disk Drive 1212. If the user plays back the content at a later time, the PRF 1208 sends it back through the CAF 1204 to utilize the MPEG multiplexing function of the CAF 1204. The MPF 1210 receives digital content from the CAF 1204 and mixes this content with computer graphics received from the PC 1214. The example of FIG. 12 depicts a set of nine different types of outputs from MPF 1210 to various audio/visual devices which interfaces can be digital or analog with or without encryption. Those skilled in the art will appreciate that more or fewer (and different types) of outputs can be provided to media processing unit 1201. A detailed description of each media flow represented by an arrow in FIG. 12 is provided in in the table of FIG. 13.

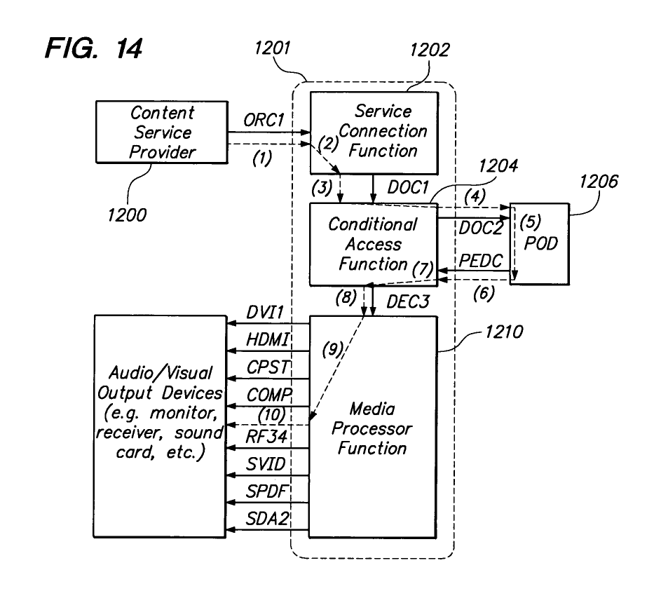

FIG. 14 shows an overlay of an exemplary digital cable programming flow onto the generic media flow diagram of FIG. 12. This illustrates the flow of digital cable programming from the content service provider 1200 through the media processing unit 1201 to its audio/visual outputs. Each flow is described below by number corresponding to the numbered, dotted arrow in FIG. 14.

1. OC1 is the content that the service provider sends to the SCF 1202. This content may or may not be CA-scrambled.

2. The SCF 1202 processes and removes the forward error correction information. It also de-multiplexes the MPEG-2 Multiple Program Transport Stream (MPTS), preserving only the program of interest with its associated video and audio and metadata.

3. The SCF 1202 sends an MPEG-2 Single Program Transport Stream (SPTS) to the CAF 1204 (DOC1).

4. The same MPEG-2 SPTS is sent to the POD 1206 (DOC2).

5. The POD 1206 CA-descrambles the content if required. It may apply DES encryption to the content as determined by content protection requirements.

6. The POD 11206 sends the MPEG-2 SPTS with possible DES encryption (PEDC).

7. The CAF 1204 performs DES decryption on the media stream if required.

8. The CAF 1204 DTCP-encrypts the content ands sends it to the MPF 1210 (DEC3).

9. The MPF 1210 removes the DTCP encryption. It then prepares the content for the appropriate output. For analog video outputs, it must perform D/A conversion. It must also separate (and potentially decode) the audio from this stream.

10. The MPF 1210 sends the content to audio/visual output devices over a variety of different interfaces.

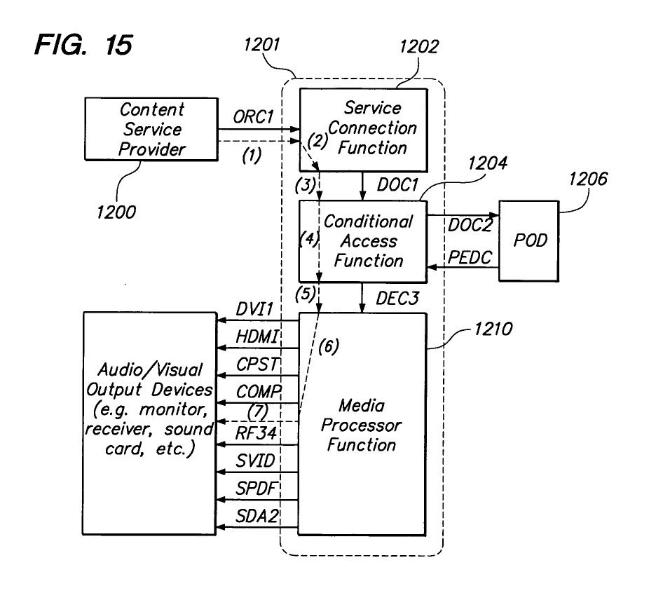

FIG. 15 overlays an exemplary analog cable programming flows onto the generic media flow diagram of FIG. 12. This illustrates the flow of analog cable programming from the content service provider 1200 through the media processing unit 1201 to its audio/visual outputs. Each flow is described below by number corresponding to the numbered, dotted arrow in FIG. 15.

1. The content service provider 1200 sends analog cable programming to the Service Connection Function 1202 (ORC1). This content will not be CA-scrambled.

2. The SCF 1202 digitizes and compresses the analog media. Video is converted to MPEG-2 format and audio into AC-3 format. The SCF 1202 forms an MPEG-2 SPTS.

3. The MPEG-2 SPTS is sent to the CAF 1204 (DOC1).

4. The CAF 1204 passes content through to its output interface to the MPF 1210. Conditional Access and POD processing is not performed on analog cable programming.

5. The CAF 1204 DTCP-encrypts the content ands sends it to the Media Processor Function 1210 (DEC3).

6. The MPF 1210 removes the DTCP encryption. It then prepares the content for the appropriate output. For analog video outputs, it must perform D/A conversion. It must also separate (and potentially decode) the audio from this stream.

7. The MPF 1210 sends the content to audio/visual output devices over a variety of different interfaces.

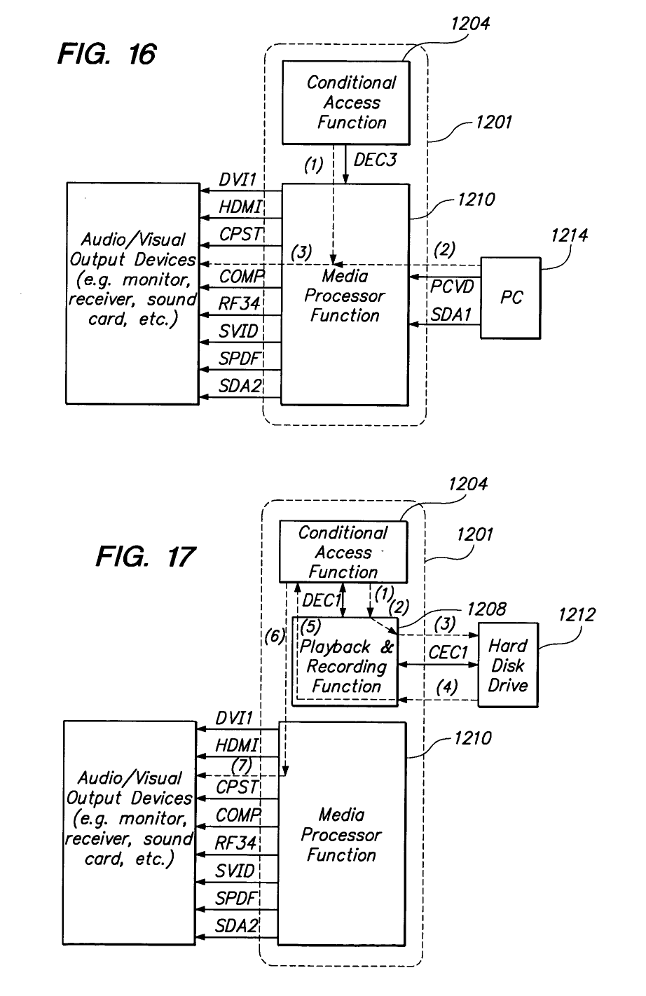

FIG. 16 shows how media mixing can be performed in an exemplary media processing unit 1201 employing the split architectures described above. Each flow is described below by number corresponding to the numbered, dotted arrow in FIG. 16.

1. The CAF 1204 sends an MPEG-2 MPTS with DTCP encryption to the MPF 1210 (DEC3).

2. The PC 1214 sends PC Video and Analog Audio to the MPF 1210 (PCVD and SDA1).

3. The MPF 1210 mixes the video and audio appropriately and sends to the correct output interface.

FIG. 17 illustrates how an exemplary media processing unit according to the present invention can perform local recording and playback. The user can record and playback simultaneously or separated in time. Each flow is described below by number corresponding to the numbered, dotted arrow in FIG. 17.

1. The CAF 1204 sends an MPEG-2 MPTS with DTCP encryption to the PRF 1208 (DEC1).

2. The PRF 1208 removes the DTCP encryption and applies CPRM encryption to the content.

3. The CPRM encrypted is sent to the hard disk drive 1212 (CEC1).

4. The PRF 1208 reads CPRM encrypted content from the hard disk drive 1212(CEC1).

5. The PRF 1208 removes the CPRM encryption, applies DTCP encryption to the MPEG-2 MPTS and sends to the CAF 1204 (DEC1).

6. The CAF 1204 multiplexes the MPEG-2 MPTS into its output stream and sends it to the MPF 1210 using IEEE-1394a-DTCP.

7. The MPF 1210 removes the IEEE-1394a-DTCP encryption and prepares the content for output to various audio/visual devices.

Various modifications and changes to the aforedescribed exemplary embodiments are contemplated. For example, the access module could be implemented as a PCI plug-in card for a computer as described above or as a standalone, self-enclosed module that is otherwise connected thereto. Different types of middleware could be used, e.g., CORBA or .net. If the CAF 1204 and MPF 1210 are integrated into one device (an alternative to FIG. 11, then an IEEE 1394 interconnect using DTCP is not needed). The various exemplary embodiments of the present invention achieve the ability to protect confidential and privileged cable data and rights as intended by, e.g, OCAP, while allowing the greater resources of a general computing environment to be more fully brought to bear on advanced applications e.g., media, gaming and commerce applications.

The above-described exemplary embodiments are intended to be illustrative in all respects, rather than restrictive, of the present invention. Thus the present invention is capable of many variations in detailed implementation that can be derived from the description contained herein by a person skilled in the art. All such variations and modifications are considered to be within the scope and spirit of the present invention as defined by the following claims. No element, act, or instruction used in the description of the present application should be construed as critical or essential to the invention unless explicitly described as such. Also, as used herein, the article “a” is intended to include one or more items.

1. A method for generating video output based on data received from a cable input comprising the steps of:
receiving said cable input in an access module;
demodulating and providing conditional access to at least some of said cable input in said access module;
transferring said at least some of said cable input from said access module to a media processing module;
receiving computer-generated graphics in said media processing module; and
mixing said at least some of said cable input and said computer-generated graphics in said media processing module to generate said video output.

2. The method of claim 1, wherein said step of providing conditional access further comprises the step of:
providing conditional access using OCAP conditional access techniques.

3. The method of claim 1, wherein said step of transferring further comprises the step of:
transferring said at least some of said cable input to said media processing module via an interconnect which ensures digital rights management (DRM) protocols.

4. The method of claim 3, wherein said interconnect is an IEEE 1394 bus employing DTCP.

5. A computer video system comprising:
an access module for receiving a cable input, demodulating said cable input and extracting data streams associated with a customer access from said demodulated cable input;
an interconnect for transferring said extracted data streams to a media processor module;
wherein said media processor module also receives computer-generated graphics and mixes said extracted data streams with said computer-generated graphics to generate a video output stream.

6. The computer video system of claim 5, wherein said interconnect is an IEEE 1394 bus employing DTCP protocols.

7. A cable data processing system comprising:
a first module, inaccessible by a general processor associated with a computer, including privileged application program interfaces (APIs) for operating on an incoming cable data stream; and
a second module, accessible by said general processor associated with said computer, including safe APIs for operating on said incoming cable data stream.

8. The cable data processing system of claim 7, wherein said privileged APIs are a first subset of OCAP-specified APIs and said safe APIs are a second subset of OCAP-specified APIs.

9. The cable data processing system of claim 8, wherein at least one API is replicated in both said first subset and said second subset of OCAP-specified APIs.

10. A cable data input card for a computer comprising:
an RF input capable of receiving a coaxial cable that conveys cable data to said cable data input card;
a PCMCIA slot having a PCMCIA card inserted therein, said PCMCIA card including a conditional access function for selectively allowing access to data streams within said cable data; and
an output which outputs those of said data streams authorized by said conditional access function to a secure interconnect.
